(19) United States
(12) Patent Application Publication
(10) Pub. No.: US 2002/0107822 A1
(43) Pub. Date: Aug. 8, 2002

(54) Uncertain and complex system teaches neural networks

(76) Inventor: Joseph Dale Helmick, Columbus, OH (US)

Correspondence Address: Joseph Dale Helmick, 2235 Waters Edge Blvd., Columbus, OH, 43209, US

(21) Appl. No.: 09/878,811

(22) Filed: Jun. 10, 2001

Related U.S. Application Data
(60) Provisional application No. 60/216,455, filed on Jul. 6, 2000.
(60) Provisional application No. 60/256,445, filed on Dec. 19, 2000.

(51) Int. Cl. G06F 15/18

(52) U.S. Cl. 706/26; 706/15

(57) ABSTRACT

Three algorithms enumerate the decimal expansions of e, π, (2)^{½} and (3)^{½} by using 1.) 16 special angles in radians on the unit circle in a transition from arbitrary-degrees to natural-radians defined as Δ (match-with-rotate algorithm), 2.) subsets of 7-1 special angles from 5π/6 to 5π/3 derived from the Pythagorean theorem such that −(−a)=−a, the square of imaginary i, i.e. i² does not equal −1, −does not equal −1, (−1)^{½}=i, (−)^{½}=yod (cusp root method algorithm), the 10^{th} letter of the Hebrew alphabet, akin to iota of Semitic origin, and 3.) 16 special angles in radians on zero vector algorithm defined in terms of the yod null set of only θ on the unit origin in polar coordinates, for the seed matrices as the mechanisms of sequence extraction whereby numerical-based-learning algorithms focusing on Artificial Neural Networks learn nonlinear functional mapping from an uncertain and complex non-congruential system for control and numerical modeling.

### BACKGROUND OF THE INVENTION

1. Field of the Invention

The invention presents an uncertain and complex system of non-congruential algorithms that teaches Artificial Neural Networks nonlinear functional mapping for control and numerical modeling, and among the more particular, to manipulate generated output of multiple sequences and to implement a new operating system.

### SUMMARY OF THE INVENTION

Analysis of the two most widely used transcendental numbers e and π extends from classical mechanics to mathematical applications like computing billions of digits of π. The computation of digits to extraordinary lengths demonstrates the value of mathematics to computer science. Introspection on the quantum aspect of the decimal expansions of e, π, (2)^{½} and (3)^{½} is more intuitively understood from the statistical mechanics of decimal positions relative to special angles in degrees and radians on the unit circle. “Numerical-learning-based algorithms focusing on Artificial Neural Networks”, i.e. Multilayer Perceptron Network, Kohonen Self-Organizing Network, and Hopfiield Network have not yet learned the “nonlinear mapping functions for control and numerical modeling from input sets to output sets” of this uncertain non-congruential system.

Application of the non-standard theory −(−a)=−a extends from arbitrary degrees to a measure of the natural scale of Euclidean geometry with a secondary extension to a complex group of symmetric and descending objects with one embedded quatermionic orbit. At the end of the −(−a)=−a yod group descent, 5π/4 on the unit circle makes sense in terms of −x=−y for a logical approach to a definition of zero vector in polar coordinates. Numeric simulations of the algorithms at 1,000,000 LengthOfString digits display preliminary evidence of convergence by the output of many sequences.

Output from e, π, (2)^{½} and (3)^{½} consist of subsets that are represented numerically in computational control. The zero exception in the denominator of the multiplicative inverse property is better understood from numeric simulations of yod and the zero vector formation that is consistent with preliminary evidence for convergence by recurring 3 and 4-tuples.

The values (2)^{½} and (3)^{½} are specifically chosen because 2 and 3 are the only operands of the square root function in the solutions to sine, cosine and tangent computations from the standard double negative equals a positive view of the Pythagorean theorem and the special angles on the unit circle. Furthermore, operation of the zero factor property is questioned in the multiplicative identity of zero when defined as an operation of repeated addition. Last, propositional functions are constructed from the extraction of numerical sequences.

The reason why the isosceles triangle of Hilbert's 7^{th} problem was chosen to triangulate the mechanism of extraction (Δ) is because the angle and length ratios are in pairs just as the special angle seed matrices extract digit pairs from e and π, (2)^{½} and (3)^{½}. Since there are only 3 angles and 3 sides to the Hilbert isosceles triangle, then only three input values run simultaneously appear to make sense. But the operands 2 and 3 appear in the trigonometric computations of the Pythagorean theorem on the unit circle. Therefore, (2)^{½} and (3)^{½} are included as separate simulations the same as e and π, and all four input values are tested as well. Also the one-to-one correspondence of decimal positions to arbitrary degrees on the unit circle and the one-to-one correspondence of degrees-radians conversion imply a special angles in radians to decimal positions one-to-one correspondence thereby completing the isosceles triangle.

### BRIEF DESCRIPTION OF THE DRAWINGS

FIG. 1 shows a map of the closed loop for the uncertain and complex system;

FIG. 2 shows a flowchart of match-with-rotate algorithm (Δ operator) for arbitrary degrees-natural radians transition;

FIG. 3 shows a flowchart of cusp root method that derives (−)^{½}=yod;

FIG. 4 shows a detailed view of FIG. 1, referenced by zero vector, which displays the 16 special angle seed matrix;

FIG. 5 shows an edge representation of the seed matrices in special angles (solid lines);

FIG. 6 shows a graph with curve of matching digits and matching special angles clustering;

FIG. 7 shows a simplified closed loop system in terms of seed matrix symmetry.

### DETAILED DESCRIPTION OF THE INVENTION

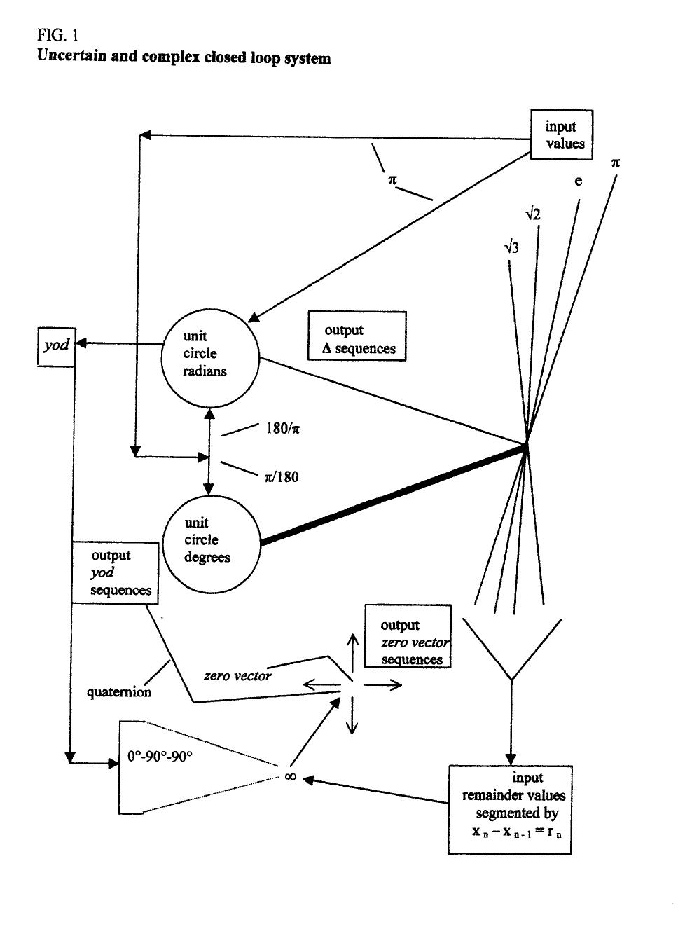

The uncertain and complex closed loop of FIG. 1 represents an uncertain and complex system with phase space transitions of arbitrary degrees to natural radians, natural radians to yod, and yod to zero vector. The nonlinear functional mapping from input to output of each operator, Δ representing match-with-rotate algorithm, yod representing cusp root method, and zero vector algorithm needs to be defined. Therefore numerical-learning-based algorithms focusing on Artificial Neural Networks are used as learning tools for control and numerical modeling from input to output sets.

System architecture is devised from an intuitive relation of geometric angles between the decimal expansions of e and π, (2)^{½} and (3)^{½}, and the arbitrary degrees-natural radians conversion on the unit circle. A complex composition of functions orients the system to a symmetrical convergence of descending objects, which lead to a definition of zero vector.

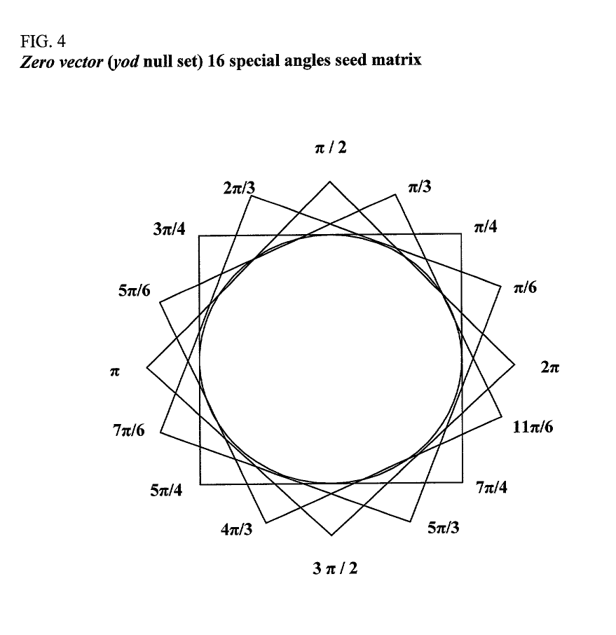

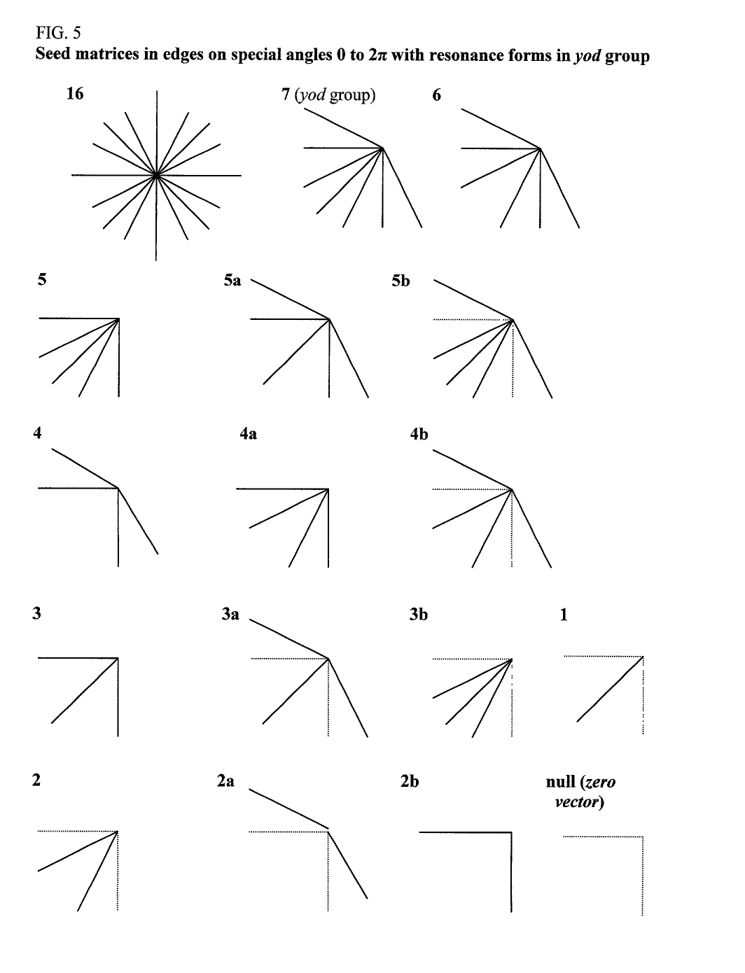

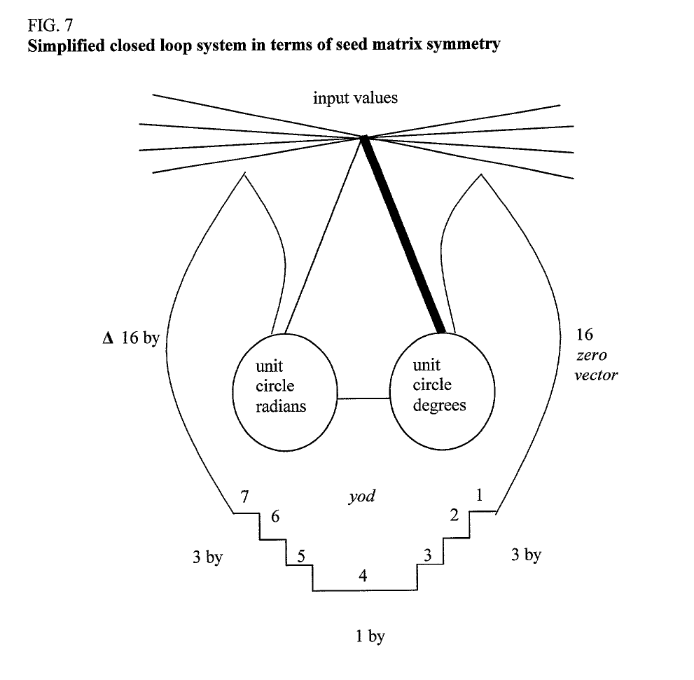

The seed matrices in edges for each operator are graphically represented in FIG. 5 with all 16 special angles (0πk to 2πk) for Δ, 7-1 combinations of special angles for 5π/6, π, 7π/6, 5π/4, 4π/3, 3π/2, 5π/3 with 3 resonance isomers in orbits 5, 4, 3, and 2 (FIG. 5) and an infinite loop in FIG. 5(4) and 16 seed matrices in zero vector (FIG. 4) demonstrate symmetrical systems of 16 by 7 by 16, branching to 16 by 3 by 1 by 3 by 16 (FIG. 7). Matching digits for FIG. 5, 5(6, 3, 2 . . . ) and 5b (6, 4, 6 . . . ) are different. Data output from 5a and all orbits in 4, 3, and 2 FIG. 5 may be amended.

As a set of edges, special angles or vectors, the null set is part of the yod group by the Power Set Axiom. For this reason the null set of the yod group makes sense when defined as zero vector in terms of only θ on the unit origin in polar coordinates.

“Numerical-based-learning algorithms can find a set of mapping functions that best approximate the output for every set of inputs by using an optimization process that updates the structure as more and more data become available and adjusts to the new situations,” for example a step-function in the yod group.

Samples of data output sequences are embedded with 3-tuple and 4-tuple elements. Examples of 3-tuples are (9, 9, 9), (7, 7, 7), and (4, 4, 4) and 4-tuple (9, 9, 9, 9) in Δ; 3-tuples (3, 3, 3), (7, 7, 7), and (1, 1, 1) and 4-tuples (4, 4, 4, 4,) and (6, 6, 6, 6,) in yod orbit 7; and 4-tuple (7, 7, 7, 7) in zero vector. The subsets and 3 and 4-tuples demonstrate well ordering such that combinatorial collections are determined by the Axiom of Choice in the Cantorian sense where the definition of set “as a combinatorial collection is more versatile and functional than the logical construction of a set as determined by a rule.” “Like the input to a network, the result of a neural computation is exhibited as a pattern of output, i.e. a collection of processors whose output is sent to an external receiver. Expected patterns of output for a given pattern of input can be defined by numerical-based-learning algorithms.”

Also, the output from Δ, yod, and zero vector sequences consist of sequences of matching digits, and matching special angles in degrees or radians that can be represented as infinite sums in telescopic series, matching special angle positions, and matching special angle positions in terms of sector-area. The variable ξ=matching digits, μ=matching special angles, and v=index of position for matching digits and matching special angles in degrees.

$${\sum }_{v = 1}^{∞} {ξ}_{v} - {ξ}_{v - 1} = {Ψ}_{ξ}$$

The series of matching digits is convergent when the matching digits are always the same digit and repeats the same digit after reaching the limit, otherwise the series diverges.

$${\sum }_{v = 1}^{∞} {μ}_{v} - {μ}_{v - 1} = {φ}_{μ}$$

The series of matching special angles is convergent if there are no more matches in position according to special angles, otherwise if there are infinite many matches, the series diverges.

Matching special angle positions (1-16 mod 360) in terms of sector-area are represented by 1.) if (μᵥ mod 360)≧180°

$${\sum }_{v = 1}^{∞} \frac{( 360 - {μ}_{v} μοδ360 )}{360} ( π ) = {τ}_{μ}$$

and by 2.) μᵥ mod 360<180

$${\sum }_{v = 1}^{∞} \frac{{μ}_{v} μοδ360}{360} ( π ) = {τ}_{μ}$$

The series of matching positions in terms of sector-area is convergent if μᵥ mod 360 is always zero after a certain point, otherwise the series diverges. In the convergent case, binary application of the matching special angle positions in sector-area mod 360 is valuable in signal processing of numeric simulations.

A quatemion is an element of a system of four dimensional vectors (FIG. 5, 4) obeying laws similar to those of complex numbers. In addition, the quaternion of infinite loop is embedded in the yod group and generates the output comment “Power::infy:Infinite expression 1/0 encountered.” The quatemion is also pictured in the closed loop of FIG. 1 in the sense of a short-cut path to zero vector when part of the symmetrical system 16 by 3 by 1 (infinite loop) by 3 by 16 such that the symmetry of the numerical system embodies a closed loop of controlled chaos when applied to the Linear-Quadratic-Gaussian with Loop-Transfer-Recovery (LQC/LTR) methodology for propulsion.

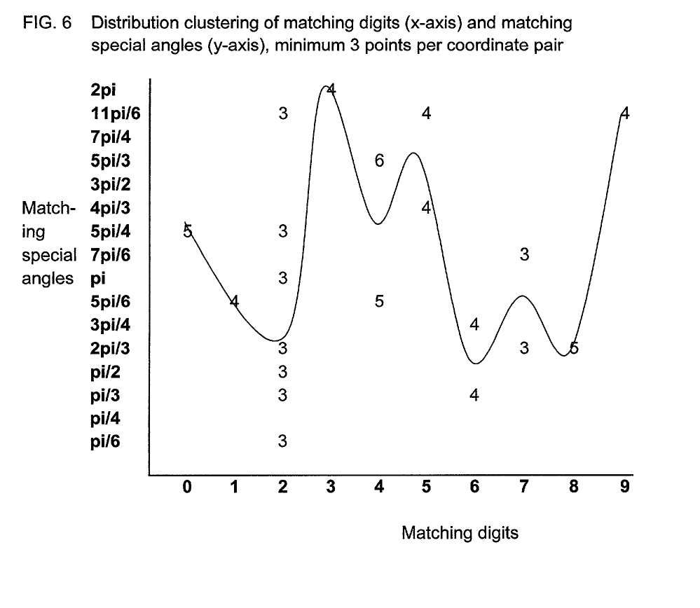

The output sequences for all combinations of seed matrices in 1.) matching digits 2.) matching special angles in degrees or radians 3.) matching special angle positions 4.) matching special angle positions in terms of sector-area and 5.) one, two, three, or four input remainder values segmented by xₙ−xₙ₋₁=rₙ with empty digit positions intact where the matching digits were extracted from, extend to infinity defined as 1/0 at the origin and are symbolized by the non-Euclidean 0°−90°−90° intermediary structure. The sequences recombine in permutations of an extraneous dimension at the origin of polar coordinates. A graph of the distribution of matching digits and matching special angles for 286 coordinate pairs (of which 76 are noted on the graph) (FIG. 6) shows symmetry of bilateral concavities and suggests a relation common to matching digits and matching special angles.

The total number of generated sequences depends on the number of input values. The input remainder values segmented by xₙ−xₙ₋₁=rₙ where the matching digits are segmented according to the factor theorem such that, if r (decimal position of matching digits) is a zero of the polynomial P₍ₓ₎ (input values) then (x−r) is a factor of P₍ₓ₎. The decimal position of matching digits is defined as a segment length from x₀=0 for the start of e, π, (2)^{½} and (3)^{½} in combinations of two, three and four input values, and x₁=decimal position of the first matching digits, then x₁−0=r₁, x₂−x₁=r₂, . . . xₙ−xₙ₋₁=rₙ and for each extracted digit position, a term from the matching special angle sequence is inserted in a one-to-one correspondence as the y-component (for height on the unit circle) in an ordered pair such that (xₙ−xₙ₋₁=rₙ, matching special angle) equals the (x, y) coordinate pair. The matching special angle positions sequence in terms of sector-area are also matched in a one-to-one correspondence with the (xₙ−xₙ₋₁=rₙ, matching special angle) coordinate pairs such that the digits of the x-component are distributed in clusters (according to frequency of digits occurring in the x-component) over the sector-area. The coordinate pair y-component (matching special angles) is the height on the unit circle and is one-to-one correspondence with the matching special angle positions (in terms of sector area).

Zero vector is determined by θ only and corresponds to the null set (FIG. 5) of the yod group, for example in the 16 special angles from 0+0πk+0 to 0+2πk+0 on the polar origin. Implementation of a non-Euclidean metric 0°−90°−90° triangle (FIG. 1) is an example of a random tool designed for an infinite task. Definition of zero vector and elementary properties of vectors in a probability context suggest the curvature of a line between 2 points on a non-Euclidean surface results in the behavior of “shortest” lines such that 1.) a ±0 domain with +0 intersect −0=vacuous, 2.) vacuous does not equal True or False, 3.) null intersect null=disjoint, and 4.) α does not equal zero, α such that α²=0, 4.) sum of vectors in the identity element law is non-commutative by a +0 does not equal 0+a, 5.) the commutative property of multiplication defined as a repeated series of addition such that adding zero five times is valid but adding 5 zero times is not valid, and 6.) the four values of minimum-maximum ±∞=1 of an operating system.

The non-Euclidean 0°−90°−90° metric, which extends to infinity at the vertex, is an intermediate form of the Δ Hilbert isosceles triangle. In the 0°−90°−90° metric, however, the ratio of orthogonal base angles to the vertex angle at infinity present polar coordinates at the origin that depend only on θ for the direction of “shortest” lines radii.

The balanced ratios of the uncertain system are: (16/16; 7/16 6/16 5/16 4/16 3/16 2/16 1/16; 16/16) that corresponds to 16 by 7 by 16 symmetry and (16/16; 7/16 6/16 5/16; 4/16 (infinite loop); 3/16 2/16 1/16; 16/16) that corresponds to 16 by 3 by 1 by 3 by 16 symmetry (FIG. 7) and the case 16 by 8 for null set=zero vector as an element of yod.

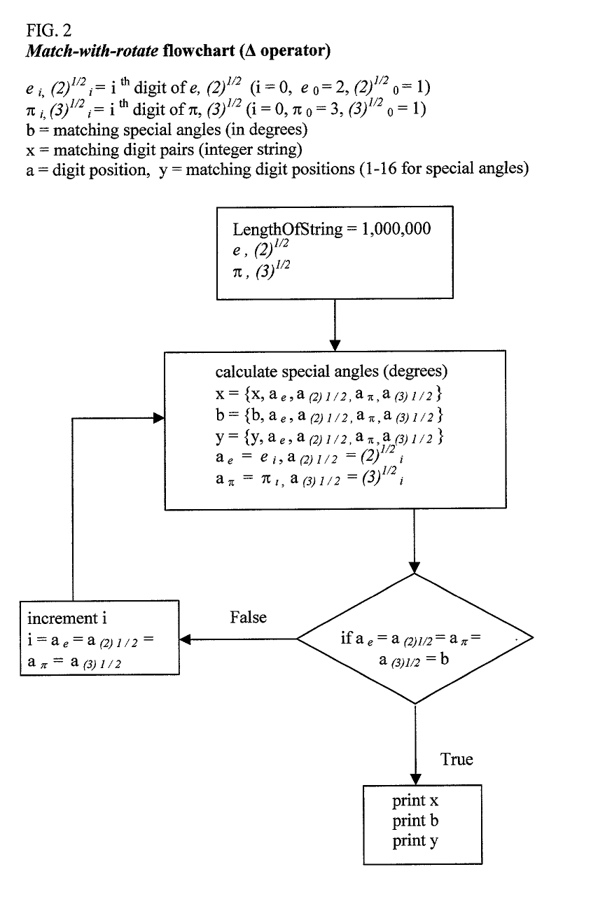

Match-with-rotate flowchart (FIG. 2) has an internal representation of input values e, π, (2)^{½} and (3)^{½} in a base 10, base 2, base 8 or base 16 system including base 10 for interpretation. Special angles are represented by, for example, π/2 as 0+2πk+30+60 or 3π/2 as 0+2πk+30+60+180 for all 16 special angles.

Match-with-rotate algorithm counts the digits in combinations of e, π, (2)^{½} and (3)^{½} starting with the first digit and not counting the place descriptor decimal point. Each of 16 special angles from 0πk to 2πk (where k is greater than or equal to 1) is counted in degrees of π=180. The sequence of special angles consists of those angles mod 360, which correspond to the 16 special angles between 0 and 2π. If the digits of e π, (2)^{½} and (3)^{½} decimal expansions match at the same position and the position has a one-to-one correspondence to the same number of degrees defined by a special angle on the unit circle, the algorithm generates an integer sequence of matching digit pairs, a radian sequence of matching special angles, a special angle position sequence, and the special angle position sequence in terms of sector-area.

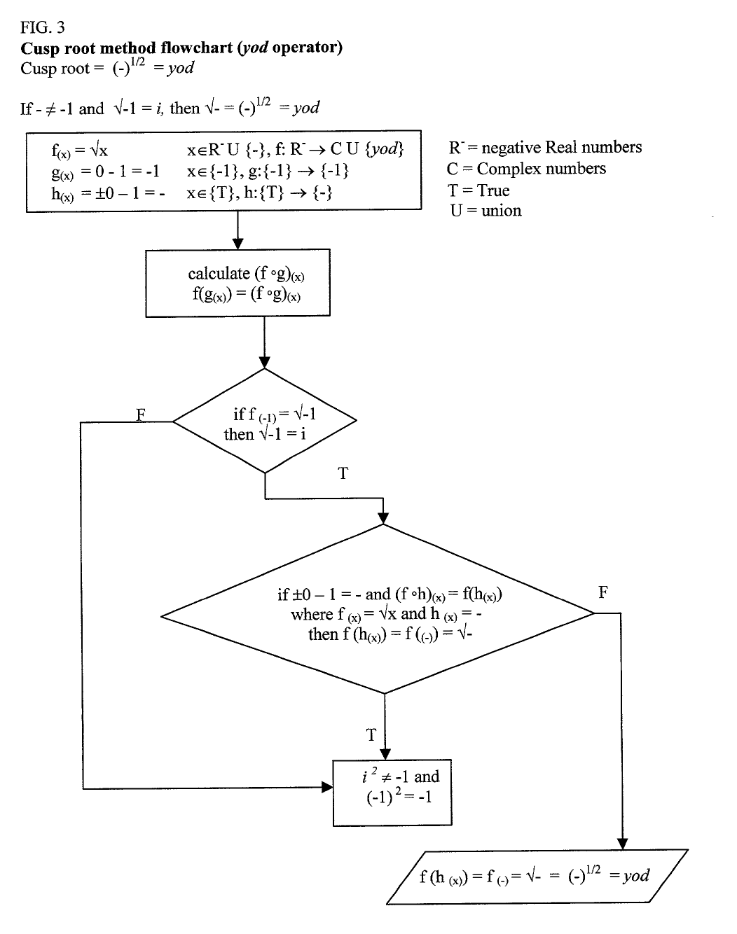

Similar in function to match-with-rotate algorithm, cusp root method (FIG. 3) is defined as one factored from the square root of negative one. The fundamental definition of yod as a complex number, is the square root of a negative sign, (−)^{½}. Derived from the Pythagorean theorem and −(−a)=−a, the result is a 7-element seed matrix symmetric about and including 5π/4 (5π/6, π, 7π/6, 5π/4, 4π/3, 3π/2, 5π/3). Table 1 shows the Pythagorean equations using −(−a)=−a for (−)^{½}=yod computations in 8-14. Secondary results are numbers 7 and 15 where c=0, numbers 1-5 where c=1, and numbers 6 and 16 where c=√2/2.

TABLE 1
Pythagorean equations to determine (−)^{1/2} = yod from 16 special angles
on the unit circle from zero to 2π

1. (cosine 0)² + (sine 0)² = c²
1² + 0² = c²
c = 1
2. (cos π/6)² + (sin π/6)² = c²
(√3/2)² + (1/2)² = c²
3/4 + 1/4 = c²
c = 1
3. (cos π/4)² + (sin π/4)² = c²
(√2/2)² + (√2/2)² = c²
1/2 + 1/2 = c²
c = 1
4. (cos π/3)² + (sin π/3)² = c²
(1/2)² + (√3/2)² = c²
c = 1
5. (cos π/2)² + (sin π/2)² = c²
0² + 1² = c²
c = 1
6. (cos 2π/3)² + (sin 2π/3)² = c²
(−1/2)² + (√3/2)² = c²
−1/4 + 3/4 = c²
1/2 = c²
C = √2/2
7. (cos 3π/4)² + (sin 3π/4)² = c²
(−√2/2)² + (√2/2)² = c²
−1/2 + 1/2 = c²
c = 0
8. (cos 5π/6)² + (sin 5π/6)² = C²
(−√3/2)² + (1/2)² = c²
−3/4 + 1/4 = c²
c² = −1/2
c = (√ − 1/2) = ((√−)√2/2) = (−)^{1/2}√2/2
9. (cos π)² + (sin π)² = c²
−1 + 0² = c²
c = √−1 = √− = (−)^{1/2}
10. (cos 7π/6)² = (sin 7π/6)² = c²
(−√3/2)² + (−1/2)² = c²
−3/4 + −1/4 = c²
−1 = c²
c = √ − 1 = √− = (−)^{1/2}
11. (cos 5π/4)² + (sin 5π/4)² = c²
(−√2/2)² + (−√2/2)² = c²
−1/2 + −1/2 = c²
−1 = c²
c = √ − 1 = √− = (−)^{1/2}
12. (cos 4π/3)² + (sin 4π/3)² = c²
(−1/2)² + (−√3/2)² = c²
−1/4 + −3/4 = c²
c² = −1
c = √− = (−)^{1/2}
13. (cos 3π/2)² + (sin 3π/2)² = c²
0² + (−1)² = c²
c² = −1
c = √− = (−)^{1/2}
14. (cos 5π/3)² + (sin 5π/3)² = c²
(1/2)² + (−√3/2)² = c²
1/4 + −3/4 = c²
c² = −1/2
c = (√ − 1/2) = ((√−)√2/2) = (−)^{1/2}√2/2
15. (cos 7π/4)² + (sin 7π/4)² = c²
(√2/2)² + (−√2/2)² = c²
1/2 + −1/2 = c²
c = 0
16. (cos 11π/6)² + (sin 11π/6)² = c²
(√3/2)² + (−1/2)² = c²
3/4 + −1/4 = c²
1/2 = c²
c = √2/2

An important point to note in determining the nonlinear functional mapping of the transition from Δ to yod is that (−)^{½}=yod is derived from: (a.) (−1)^{½}=i (b.)±0−1=−(FIG. 3) and (c.) the 7 seed matrices of yod are a subset of the Δ 16 seed matrices for special angles on the unit circle.

The three conditions for the phase space transition from Δ to yod make the system loop complex and uncertain at the conditional points in space-time as we look from inside of logic as a rule. But viewed from outside of logic in an intuitive sense, a disjoint operating system can be learned by numerical-learning-based algorithms focusing on Artificial Neural Networks.

Also similar in function to match-with-rotate algorithm, zero vector (FIG. 4) uses 16 special angles in radians on zero vector defined in terms of the yod null set of only θ on the unit origin of polar coordinates, for example, 0+(3π/4)k+0 or 0+πk+0.

The 16/16 ratio of zero vector is the same as the 16/16 ratio of Δ. When Δ and zero vector are viewed as stabilizers that bracket the yod group, the descending objects of yod orbits 7-1 descend numerically, but in a sense of a symmetric structure about 5π/4, the orbits descend from 7 to 4 and ascend from 4 to 1 similar to a step-function in a v-shape that is being compressed. FIG. 7 shows a v-formation of yod with quaternion yod orbit 4 leading a symmetrical approach that converges on zero vector in closure of the loop.

The operators Δ, yod, and zero vector are implemented by appending to the wave equation to detect objects in surveys of the sky. The transmission of signals generated from the sequences is also important for communications in signal to noise ratios. Sky surveys with electromagnetic transmitters need to append Δ a transfinite complex number to the wave equation so that the transition from degrees to ωin radians can be realized. Yod and zero vector are also appended so results can be tracked through the system loop.

| | |
|---|---|
| ∂² Ey/∂ t² = A cos [ωt + Δ φ°] | A = amplitude, ω = radian frequency, and |
| | φ = phase in degrees |

∂² Ey/∂ t² = A cos [(−)^{1/2}ωt + φ°]
∂² Ey/∂ t² = A cos (ωt + φ°) (zero vector)
∂² Ey/∂ t² = A cos [(−)^{1/2}ωt + Δ φ°]
∂² Ey/∂ t² = A cos [(−)^{1/2}ωt + Δ φ°]
(zero vector)

For actuation in signal processing of numeric simulations of measurements to detect objects in the sky using electromagnetic mathematical modeling and electromagnetic measurement systems involves problems and applications of signal identification, data compression, and nonlinear functional mapping. The operators Δ=mechanism of extraction for match-with-rotate algorithm, (−)^{½}=yod for cusp root method algorithm, and zero vector algorithm open new dimensions for finer resolution and less noise.

In a similar technique, the operators Δ, yod, and zero vector are appended to equations of acceleration and velocity for displacement in electrical and mechanical systems. For acceleration and velocity in “undamped and damped free vibrations of mechanical and electrical oscillations, displacement u(t) in mu ”(t)+gamma u′(t)+ku(t)=F(t) is only approximate. But for an undamped example, the general solution of the equation of motion mu ″+ku=0 is U₍ₜ₎=A cos ω₀t+B sin ω₀t where (ω₀)²=k/m for A=R cos δ and B=R sin δ, R=(A²+B²)^{½} and tan δ=B/A. The period of the motion is given by T=2π/ω₀=2π(m/k)^{½} with the circular or natural frequency of vibration ω₀=(k/m)^{½} and is measured in radians per unit time, a dimensionless scale,” but for Δ, yod, and zero vector dimension is possible. “The amplitude of the motion is defined by R, the mass at equilibrium, and the phase angle, represented by the dimensionless parameter δ called the phase, measures the displacement of the wave from its normal position, δ=0, so the general solution” u₍ₜ₎=A cos ω₀t+B sin ω₀t can also be modified according to the complex operators Δ, yod, and zero vector as in for example u₍ₜ₎=A cos (−)^{½}ω₀t+B sin (−)^{½}ω₀t with u₍ₜ₎=R cos(ω₀t−δ) and δ=tan⁻¹(B/A).

| | |
|---|---|
| velocity = −Aω sin[ωt + Δ φ] | φ = phase angle in degrees |
| acceleration = −Aω² cos[ωt + Δ φ] | |
| velocity = −Aω(−)^{1/2}sin[(−)^{1/2}ωt + φ] | φ = phase angle in degrees |
| acceleration = −Aω²(−)^{1/2}cos[(−)^{1/2}ωt + | |
| φ] | |
| velocity = −Aω(−)^{1/2}sin[(−)^{1/2}ωt + Δ | φ = phase angle in degrees |
| φ] | |
| acceleration = −Aω²(−)^{1/2}cos[(−)^{1/2} | |
| ωt + Δ φ] | |
| velocity = −Aω(−)^{1/2}sin[(−)^{1/2}ωt + | φ = phase angle |
| Δ φ] (zero vector) | in degrees |
| acceleration = −Aω²(−)^{1/2}cos[(−)^{1/2} | |
| ωt + Δ φ] (zero vector) | |

Last, the new dimensionalities of yod, and the whole system including Δ and zero vector provides new space to store data inputs in computer hardware and software (like Windows clipboard) and “responds to new and complex ways to the data.” Intelligent yod, Δ, and zero vector are able to monitor and store many more data inputs over current high volumes and maintain the data inputs at low cost.

I claim:

1. Numeric control and modeling of an uncertain and complex non-congruential generator system of algorithms defined by multiple seed matrices of 1.) match-with-rotate for all 16 special angles on the unit circle 2.) cusp root method, a descending chain of 7-1 special angles from 5π/6 to 5π/3 (with resonance orbits and infinite loop) on the unit circle and 3.) zero vector, i.e. null set of yod group, for all 16 special angles from 0πk to 2πk defined in terms of only θ on the unit origin in polar coordinates, which teaches numerical-learning-based algorithms focusing on Artificial Neural Networks used for numerical modeling and control of the uncertain and complex system's dynamics and operating environment for nonlinear functional mapping consisting of:
data output for all combinations of seed matrices in sequences of 1.) matching digits 2.) matching special angles in degrees or radians 3.) matching special angle positions 4.) matching special angle positions in terms of sector-area and 5.) one (relative to another), two, three or four input remainder values segmented by (xₙ−xₙ₋₁)=rₙ with empty digit positions intact where the matching digits were extracted from, which are used individually or recombine in permutations to close the system loop and;
programs coded with the algorithms of the operators Δ representing match-with-rotate algorithm, yod representing cusp root method algorithm, and zero vector algorithm that produce the data output sequences and;
3-tuple and 4-tuple elements embedded in well-ordered data output sequences for combinations of input values and each combination of seed matrices.

2. Numeric control and modeling of an operating system or environment that consists of but is not limited to the properties, −(−a)=−a,±0−1=−,i² does not equal −1, and −does not equal −1, vacuous does not equal True or False, null intersect null=disjoint, sum of vectors in the identity element law is non-commutative by a+0 does not equal 0 +a, the commutative property of multiplication defined as a repeated series of addition such that adding zero five times is valid but adding 5 zero times is not valid, the four values of minimum-maximum±∞=1, and a does not equal zero, a such that a²=0.

3. The system of claim 1 wherein for numeric control and modeling of the 7-1 special angle seed matrices of yod, orbit four, a quartenion of infinite loop that generates “Power::infy:Infinite expression 1/0 encountered” as an output comment with no data for LengthOfString=1,000,000 digits.

4. The system of claim 1 for numeric control and modeling of when the sequences of data output sets in matching digits, matching special angles, matching special angle positions, matching special angle positions in terms of sector-area, and input remainder values segmented by xₙ−xₙ₋₁=rₙ from which the matching digits were extracted are coded in binary to 1.) simulink simulation code and routed to 2.) microcontroller (d-space), for mathematical modeling and 3.) microcontroller for physical processes to form circuits.

5. The sequences of claim 1 for numeric control and modeling of when the matching digits sequence is segmented according to the factor theorem, recombined by one-to-one correspondence in coordinate pairs with the matching special angles, and again matched in one-to-one correspondence with matching special angle positions so that the x-component of the coordinate pairs is distributed according to digit frequency over the sector-areas of the matching special angle positions, which are in one-to-one correspondence with matching special angles (y-component) and matching special angle positions.

6. The claim of 1 for numeric control and modeling of the phase space transitions as represented by Δ=16 special angle seed matrix, (−)^{½}=yod 7-1 special angle seed matrix, and zero vector=16 special angle seed matrix from 0πk to 2πk defined in terms of the yod null set of only θ on the unit origin in polar coordinates are appended to the wave equation in combinations when E_{y}=∂Hz/∂x,t=time, x₍ₜ₎ defined as a point in spacetime such that x₍ₜ₎=A cos (107 t+90°), and ∂²Ey/∂t²=A cos (ωt+Φ°).

7. The claim of 3 for numeric control and modeling of a controlled yet chaotic numerical control system that displays spin-scatter behavior of the infinite loop, “Power::infy:Infinite expression 1/0 encountered” within the 16 by 3 by 1 by 3 by 16 symmetry and is applied to the Linear-Quadratic-Gaussian with Loop-Transfer-Recovery (LQG/LTR) methodology for propulsion in a mechanical system.

8. The claim of 1 for numeric control and modeling of acceleration and velocity equations in undamped and damped free vibrations of mechanical and electrical oscillation displacements are modified according Δ, yod, and zero vector as operators.

9. The claim of 1 for numeric control and modeling of ratios of special angle seed matrices are for 1.) match-with-rotate 16/16 2.) cusp root method 7/16, 6/16, 5/16, 4/16, 3/16, 2/16, 1/16 and/or 0/16 for null=zero vector, with 3 resonance orbits in each of 5/16, 4/16, 3/16, 2/16 and an infinite loop in 4/16 and 3.) zero vector 16/16, as not the null set of yod.

10. The claim of 1 for numeric control and modeling of cusp root method of yod, match-with-rotate for Δ, and zero vector for high volumes and low costs of data storage in computer hardware and software.

11. The claim of 1 for numeric control and modeling of the 3 resonance orbits for each of 5, 4, 3, and 2 orbits of yod are defined as isomers.
